(19) United States
(12) Patent Application Publication
(10) Pub. No.: US 2021/0141217 A1
(43) Pub. Date: May 13, 2021

(54) OPTICAL COATING AND AN APPARATUS INCLUDING THE OPTICAL COATING

(71) Applicant: VIAVI SOLUTIONS INC., San Jose, CA (US)

(72) Inventors: Richard Alan BRADLEY, Santa Rosa, CA (US); Markus BILGER, Santa Rosa, CA (US); Georg J. OCKENFUSS, Santa Rosa, CA (US); Kelly JANSSEN, Santa Rosa, CA (US); Benjamin Franklin CATCHING, Santa Rosa, CA (US); Markus Kurt TILSCH, Santa Rosa, CA (US)

(73) Assignee: VIAVI SOLUTIONS INC., San Jose, CA (US)

(21) Appl. No.: 17/091,672

(22) Filed: Nov. 6, 2020

Related U.S. Application Data
(60) Provisional application No. 62/933,090, filed on Nov. 8, 2019.

(51) Int. Cl. G02B 27/00; G02B 5/00; G02B 1/18

(52) U.S. Cl. CPC G02B 27/0006; G02B 1/18; G02B 5/003

(57) ABSTRACT

An optical coating having a first wavelength of light range for optical heating; and a second wavelength of light range for optical sensing is disclosed. An apparatus can include the optical coating. An optical system can include the apparatus and a light source. Methods of making and using the optical coating, apparatus, and optical system are also disclosed.

### RELATED APPLICATION

The present application claims priority to U.S. Provisional Application No. 62/933,090, filed Nov. 8, 2019, the disclosure of which is hereby incorporated by reference in its entirety.

### FIELD OF THE INVENTION

The present disclosure generally relates to an optical coating having a first wavelength of light range for optical heating; and a second wavelength of light range for optical sensing. An apparatus can include the optical coating. An optical system can include the apparatus and a light source. Methods of making and using the optical coating, apparatus, and optical system are also disclosed.

### BACKGROUND OF THE INVENTION

Optical systems including external sensor windows, such as light detection and ranging (LIDAR), thermal imaging, and RGB cameras, are used in automobiles and are exposed to an external environment. For example, ice and water (both large and small droplets, such as fog) cause optical artifacts that make the optical systems unstable.

For example, in LIDAR windows, resistive heating of indium tin oxide (ITO) coatings is used to provide an effect, such as heating, defogging, de-icing, etc. The ITO coatings are present on an interior surface of a glass substrate. Resistive wires are typically used to connect the ITO coating to busbar connections. This results in two potential problems. First, resistive wires and busbar connections break making them an unreliable approach to providing heat to the ITO coating. Second, the heat generated by the heated ITO coating must still transfer through the mass of the glass substrate, which is an inefficient means for conducting heat.

What is needed is a simple optical system level integration of an optical coating that is durable (for example, repeated use in an external environment) and efficient (for example, both in cost and heat transfer).

### BRIEF DESCRIPTION OF THE DRAWINGS

Features of the present disclosure are illustrated by way of example and not limited in the following figure(s), in which like numerals indicate like elements, in which:

FIG. 1A is a graph illustrating absorption and transmission of an optical coating according to an aspect of the invention;

FIG. 1B is a graph illustrating absorption and transmission of an optical coating according to another aspect of the invention;

FIG. 1C is a graph illustrating absorption and transmission of an optical coating according to another aspect of the invention;

FIG. 1D is a graph illustrating absorption and transmission of an optical coating according to another aspect of the invention;

FIG. 1E is a graph illustrating absorption and transmission of an optical coating according to another aspect of the invention;

FIG. 1F is a graph illustrating absorption of an optical coating according to another aspect of the invention;

FIG. 1G is a graph illustrating transmission of an optical coating according to another aspect of the invention;

FIG. 2A is a schematic of an apparatus according to an aspect of the invention;

FIG. 2B is a schematic of an apparatus according to another aspect of the invention;

FIG. 2C is a schematic of an apparatus according to another aspect of the invention;

FIG. 3A is a schematic of an optical system according to an aspect of the invention;

FIG. 3B is a schematic of an optical system according to another aspect of the invention; and

FIG. 3C is a schematic of an optical system according to an aspect of the invention.

### SUMMARY OF THE INVENTION

In an aspect, there is disclosed an optical coating comprising a first wavelength of light range for optical heating; and a second wavelength of light range for optical sensing, wherein the first wavelength of light range is different from the second wavelength of light range.

In another aspect, there is disclosed an apparatus comprising a transparent substrate having a first side and a second side; and an optical coating on the first side of the transparent substrate.

Additional features and advantages of various embodiments will be set forth, in part, in the description that follows, and will, in part, be apparent from the description, or can be learned by the practice of various embodiments. The objectives and other advantages of various embodiments will be realized and attained by means of the elements and combinations particularly pointed out in the description herein.

### DETAILED DESCRIPTION OF THE INVENTION

For simplicity and illustrative purposes, the present disclosure is described by referring mainly to an example thereof. In the following description, numerous specific details are set forth in order to provide a thorough understanding of the present disclosure. It will be readily apparent however, that the present disclosure may be practiced without limitation to these specific details. In other instances, some methods and structures have not been described in detail so as not to unnecessarily obscure the present disclosure.

Additionally, the elements depicted in the accompanying figures may include additional components and some of the components described in those figures may be removed and/or modified without departing from scopes of the present disclosure. Further, the elements depicted in the figures may not be drawn to scale and thus, the elements may have sizes and/or configurations that differ from those shown in the figures.

It is to be understood that both the foregoing general description and the following detailed description are exemplary and explanatory only, and are intended to provide an explanation of various embodiments of the present teachings. In its broad and varied embodiments, disclosed herein are articles; and a method of making and using articles.

The present disclosure describes an optical coating 12 having a first wavelength of light range for optical heating; and a second wavelength of light range for optical sensing. The first wavelength of light range can be different from the second wavelength of light range. For example, if the first wavelength of light range is the visible light range, then the second wavelength of light range can be any other wavelength of light range, such as near infrared or near infrared and infrared. The dual ranges of the optical coating 12 allow the optical coating 12 to generate optical heat and to provide optical sensing, such as used in visible light imaging, infrared heat sensing, and proximity sensing.

In an aspect, the optical coating 12 can selectively absorb light in a first wavelength of light range for optical heating. The absorbed light can generate heat that can be used to heat an apparatus 20 that is exposed to an external environment. The first wavelength of light range can include a wavelength range of visible light (350 nm to 780 nm), a wavelength range of near infrared light, or a wavelength range including both visible and the near infrared light.

In an aspect, the optical coating 12 can selectively transmit light in a second wavelength of light range for optical sensing. The selectively transmitted light can be sensed by detectors present in an optical system. The second wavelength of light range can include the near infrared wavelength, the visible wavelength (350 nm to 780 nm), a short wave infrared wavelength, or a long wave infrared wavelength.

As an example, the optical coating 12 can include a first wavelength of light range, such as visible light, and a second wavelength of light range, such as near infrared. The optical coating 12 can include silicon (such as silicon-containing material, for example, lanthanum silicon or hydrogen doped silicon) as an optically absorbing material.

As shown in FIG. 1A, the optical coating 12 can be an anti-reflective coating with absorbing properties (dashed line) in a first wavelength of light range from about 350 nm to about 780 nm and transmitting properties (solid line) in a second wavelength of light range from about 940 nm to about 1950 nm. In an aspect, as shown in FIG. 1B, the optical coating 12 can be an anti-reflective coating with absorbing properties (dashed line) in a light wavelength range from about 350 nm to about 780 nm and transmitting properties (solid line) in a light wavelength range from about 905 nm to about 1950 nm. In an aspect, as shown in FIG. 1C, the optical coating 12 can be an anti-reflective coating with absorbing properties (dashed line) in a light wavelength range from about 350 nm to about 780 nm and transmitting properties (solid line) in a light wavelength range from about 1550 nm to about 2150 nm. In an aspect, as shown in FIG. 1D, the optical coating 12 can be a bandpass coating with absorbing properties (dashed line) in a light wavelength range from about 350 nm to about 780 nm and transmitting properties (solid line) in a light wavelength range from about 950 nm to about 1950 nm.

As an example, the optical coating 12 can include a first wavelength of light range, such as near infrared light or short wave infrared, and a second wavelength of light range, such as visible. The optical coating 12 can include transparent conductive coatings, such as ITO and ITIO, in place of absorbing silicon (as in the example above) or in addition to silicon-containing material, such as silicon dioxide.

As shown in FIG. 1E, the optical coating 12 can be a wide band anti-reflective coating with absorbing properties (dashed line) in a light wavelength range from about 1000 nm to about 1850 nm and transmitting properties (solid line) in a light wavelength range from about 350 nm to about 780 nm.

The first wavelength of light range and the second wavelength of light range can be customized for an optical system.

As an example, the optical coating 12 can include a first wavelength of light range, such as visible and near infrared light, and a second wavelength of light range, such as long wave infrared. The optical coating 12 can include germanium, which absorbs in wavelengths below 1500 nm, and or zinc sulfide. An optical coating 12 with germanium can typically absorb light below 1800 nm wavelength. In comparison, silicon can typically absorb light below 1000 nm wavelength. The optical coating 12 can absorb light through the second side 14 of a transparent substrate 10, such as a silicon, when a light source 136 is positioned on the second side 14 of the apparatus 20.

In an aspect, the optical coating 12 can be a long wave infrared anti-reflective coating with absorbing properties (dashed line in FIG. 1F) in a light wavelength range from about 350 nm to about 1150 nm and transmitting properties (solid line in FIG. 1G) in a light wavelength range from about 11000 nm to about 14500 nm.

The optical coating 12 can be tailored to an optical system 100 having an absorbing light source 136 and a transmitting light source 140. In particular, the optical coating 12 can be formed with an absorbing material that absorbs light from the absorbing light source in a same wavelength, such as visible light. Non-limiting examples of absorbing materials that absorb visible light for use in the optical coating 12 include silicon-containing materials, such as amorphous silicon, Si:H, Ge, Ge:H, SiGe, SiGe:H. Non-limiting examples of absorbing materials that absorb near infrared or short wave infrared light for use in the optical coating 12 include transparent conductive materials, such as ITO, ITiO, ZnO, AlZnO, FTO, and carbon nano tubes.

Additionally, the optical coating 12 can be formed with a transmitting material that transmits light from the transmitting light source in a same wavelength, such as near infrared light.

The optical coating 12 can be an anti-reflective coating. The optical coating 12 can also be a bandpass filter, a shortwave pass filter, a longwave pass filter, a notch filter, a multiband filter, etc.

The optical coating 12 can be a single layer or can be a multilayer coating. The optical coating 12 can include a single material that has the first wavelength of light range and the second wavelength of light range. In an aspect, the optical coating 12 can include a first material having the first wavelength of light range and a second material having the second wavelength of light range. The first material can be an absorbing material and the second material can be a transmitting material. Any and all combinations of materials and layers are contemplated.

In an aspect, the optical coating 12 can be opaque in visible light wavelength. In another aspect, the optical coating 12 can include colorants, such as dyes and pigments.

The optical coating 12 can be formed by various processes. Non-limiting methods of making the optical coating 12 include DC magnetron sputtering, AC magnetron sputtering, pulsed DC sputtering, thermal evaporation, e-beam evaporation, CVD, PECVD, MOCVD, ion-beam sputtering IBS, dual beam, and IBS, etc.

FIG. 2A illustrates an apparatus 20 comprising a transparent substrate 10 having a first side 16 and a second side 14; and an optical coating 12 on the first side 16 of the transparent substrate 10.

The transparent substrate 10 can be made of any transparent material. Non-limiting examples of transparent materials include glass, polymers, and resins. In an aspect, the transparent substrate 10 can be a tempered glass.

The first side 16 of the transparent substrate 10 can face an environment, such as an exterior environment, that can have uncertain and unforeseen factors. These factors can adversely affect an ability of the apparatus 20 to operate. For example, the first side 16 of the transparent substrate 10 can face towards an outside world with weather conditions, such as rain, wind, ice, and snow; and physical conditions, such as dirt, dust, insects, etc. The second side 14 of the transparent substrate 10 can face an interior environment. For example, the second side 14 of the transparent substrate 10 can face towards an inside world, such as inside an automobile or a building.

It will be appreciated that because the optical coating 12 can be present on the first side 16 of the transparent substrate 10 the optical coating 12 can heat faster as compared to an optical coating 12 present on a second side 14 of the transparent substrate 10. In particular, because the optical coating 12 can be present on the first side 16 of the transparent substrate 10 then it does not have to transfer heat through the transparent substrate 10.

FIG. 2B illustrates an apparatus 20 further comprising a functional coating 18 on the optical coating 12. In an aspect, the functional coating 18 can be a hydrophilic coating. In another aspect, the functional coating 18 can be a hydrophobic coating. A hydrophobic coating 18 can be used to keep the apparatus 20 clean, such as free from physical conditions, such as dirt, and dust. The functional coating 18 can be present on a second side 14 of the transparent substrate 10.

FIG. 2C illustrates an apparatus 20 further comprising an internal optical coating 22 on the second side 14 of the transparent substrate 10. In an aspect, the internal optical coating 22 can be a high performance anti-reflective coating. For example, the internal optical coating can be a broadband anti-reflective coating that selectively transmits visible light. In an aspect, the apparatus 20 does not include an indium tin oxide coating on the second side 14 of the transparent substrate 10.

The apparatus 20 of the present disclosure can be an external sensor window. The apparatus 20 can be used in various applications, such as an application chosen from automotive LIDAR, non-automotive LIDAR, auto RGB cameras (back-up cameras and advanced driver assist cameras), surveillance cameras, perimeter control cameras, free space optics windows, thermal imaging windows, and directed energy windows.

FIG. 3A illustrates an optical system 100 comprising an apparatus 20 including a transparent substrate 10 having a first side 16 and a second side 14, and an optical coating 12 on the first side 16 of the transparent substrate 10; and a light source 136.

The light source 136 can be any source capable of sending an output illumination. Non-limiting examples of a light source include incandescent (W filament) bulbs (can produce both visible 350 nm to 780 nm and near infrared light 800 nm to 2000 nm), LED (visible and NIR), quartz halogen, lasers (diode lasers, carbon dioxide lasers, etc.), glow bar heaters, flash lamps, and pulsed light. Pulsed light can limit interference between the light source 136 and the optical system (for example, detect 90% of the time and heat 10% of the time). Additionally, for a fixed average delivered power, pulsed light can create higher peak temperatures in the optical coating 12. Pulse width modulation can vary the average applied power, which can be useful in temperature control. The light source 136 can be matched to the absorption properties of the optical coating 12 to provide heating for defogging or de-icing processes.

The optical system 100 can include at least one absorbing light source 136, as shown in FIG. 3A, in paraxial geometry. In another aspect, the optical system 100 can also include at least one light source 136, as shown in FIG. 3B, in coaxial geometry. In another aspect, the optical system 100 can include a first absorbing light source 136 on a first side 16 of the apparatus 20 and can include a second absorbing light source 136 on a second side 14 of the apparatus 20, as shown in FIG. 3C.

The optical system 100 can include two light sources, such as a first absorbing light source 136 to provide an absorbing wavelength of light to the optical coating 12 on the apparatus 20 and a second transmitting light source 140 to provide a transmitting wavelength of light to the optical coating 12 on the apparatus 20. In an aspect, the optical system 100 can include a laser 140 and an incandescent bulb 136. The optical system can also include a diffuser to focus the light from the absorbing light source 136.

The optical system 100 can also include a detector 134. In an aspect, the absorbing light source 136 can be located between a transmitting light source 140 and the detector 134. The optical system 100 can also include a telescope 132.

The optical coating 12 of the present disclosure can eliminate the need to use expensive ITO coatings on an apparatus 20, such as on a second side 14 of a transparent substrate 10. Additionally, the optical coating 12 can eliminate the need for busbar electrical connections in an apparatus 20 and/or an optical system 100.

Because the optical coating 12 can be placed on a first side 16 of a transparent substrate 10 it allows for the placement of an anti-reflective coating 22 on the second side 14 of the transparent substrate 10. The placement of the anti-reflective coating 22 on an interior surface of the apparatus 20 can reduce back reflections into an optical system 100, such as a LIDAR system. One of ordinary skill in the art will appreciate that back reflections can generate false signals. Additionally, the placement of the optical coating 12 on a first side 16 of the transparent substrate 10 can allow for faster heating because heat transport through the transparent substrate 10 is eliminated.

A method of using an optical coating 12 comprising applying an optical coating 12 to a first side 16 of a transparent substrate 10 to form an apparatus. The optical coating 12 can have dual wavelength of light ranges to allow the optical coating 12 to generate heat and to provide optical sensing, such as in visible light imaging, infrared heat sensing, and proximity sensing. As discussed herein, the optical coating 12 can selectively absorb light in a first wavelength of light range for optical heating. The absorbed light can generate heat that can be used to heat an apparatus 20 that is exposed to an external environment. The optical coating 12 can selectively transmit light in a second wavelength of light range for optical sensing. The selectively transmitted light can be sensed by detectors present in an optical system.

A method of using an apparatus 20 comprising providing an optical coating 12 to a first side 16 of a transparent substrate 10 to form an apparatus 20; and providing the apparatus 20 to an optical system 100. The optical coating 12, the apparatus 20, and the optical system 100 are as described above.

A method of using an optical system comprising: positioning an apparatus 20 having an optical coating 12 so that the optical coating 12 receives a first wavelength of light range from an absorbing light source and receives a second wavelength of light range from a transmitting light source. The optical coating 12, the apparatus 20, and the optical system 100 are as described above.

The optical coating 12 of the apparatus 20 can be heated by the first wavelength of light from the absorbing light source. The heated optical coating 12 can defog a transparent substrate 10 of the apparatus 20.

From the foregoing description, those skilled in the art can appreciate that the present teachings can be implemented in a variety of forms. Therefore, while these teachings have been described in connection with particular embodiments and examples thereof, the true scope of the present teachings should not be so limited. Various changes and modifications can be made without departing from the scope of the teachings herein.

This scope disclosure is to be broadly construed. It is intended that this disclosure disclose equivalents, means, systems and methods to achieve the coatings, devices, activities and mechanical actions disclosed herein. For each coating, device, article, method, mean, mechanical element or mechanism disclosed, it is intended that this disclosure also encompass in its disclosure and teaches equivalents, means, systems and methods for practicing the many aspects, mechanisms and devices disclosed herein. Additionally, this disclosure regards a coating and its many aspects, features and elements. Such a coating can be dynamic in its use and operation, this disclosure is intended to encompass the equivalents, means, systems and methods of the use of the device and/or optical device of manufacture and its many aspects consistent with the description and spirit of the operations and functions disclosed herein. The claims of this application are likewise to be broadly construed. The description of the inventions herein in their many embodiments is merely exemplary in nature and, thus, variations that do not depart from the gist of the invention are intended to be within the scope of the invention. Such variations are not to be regarded as a departure from the spirit and scope of the invention.

What is claimed is:

1. An optical coating comprising:
a first wavelength of light range for optical heating; and
a second wavelength of light range for optical sensing,
wherein the first wavelength of light range is different from the second wavelength of light range.

2. The optical coating of claim 1, wherein the first wavelength of light range is a visible wavelength; and the second wavelength of light range is a near infrared wavelength.

3. The optical coating of claim 1, wherein the first wavelength of light range is a near infrared wavelength; and the second wavelength of light range is a visible wavelength.

4. The optical coating of claim 1, wherein the first wavelength of light range is a visible and near infrared wavelength; and the second wavelength of light range is a long wave infrared wavelength.

5. The optical coating of claim 1, wherein the optical coating includes colorants.

6. The optical coating of claim 1, wherein the optical coating includes a single material that has the first wavelength of light range and the second wavelength of light range.

7. The optical coating of claim 1, wherein the optical coating includes a first material having the first wavelength of light range and a second material having the second wavelength of light range.

8. The optical coating of claim 7, wherein the first material is absorbing material and the second material is a transmitting material.

9. An apparatus comprising:
a transparent substrate having a first side and a second side; and
an optical coating on the first side of the transparent substrate.

10. The apparatus of claim 9, further comprising a functional coating on the optical coating.

11. The apparatus of claim 10, wherein the functional coating is a hydrophilic coating.

12. The apparatus of claim 10, wherein the functional coating is a hydrophobic coating.

13. The apparatus of claim 9, wherein the transparent substrate is glass.

14. The apparatus of claim 9, further comprising an internal optical coating on the second side of the transparent substrate.

15. An optical system comprising:
the apparatus of claim 9; and
a light source.

16. A method of using an optical coating comprising:
applying the optical coating of claim 1 to a first side of a transparent substrate.

17. A method of using an apparatus comprising:
providing the optical coating of claim 1 to a first side of a transparent substrate to form an apparatus; and providing the apparatus to an optical system.

18. A method of using an optical system comprising:
positioning the apparatus of claim 9 so that the optical coating receives a first wavelength of light range from an absorbing light source and receives a second wavelength of light range from a transmitting light source.

19. The method of claim 18, wherein an optical coating of the apparatus is heated by a first wavelength of light from the absorbing light source.

20. The method of claim 18, wherein the heated optical coating defogs a transparent substrate of the apparatus.
